(19) United States
(12) Patent Application Publication
(10) Pub. No.: US 2020/0276523 A1
(43) Pub. Date: Sep. 3, 2020

(54) PRESSURE CONTROL DEVICE

(71) Applicant: NIDEC TOSOK CORPORATION, Kanagawa (JP)

(72) Inventors: Masaru MIYAGI, Kanagawa (JP); Kenji OOHARA, Kanagawa (JP)

(73) Assignee: NIDEC TOSOK CORPORATION, Kanagawa (JP)

(21) Appl. No.: 16/792,282

(22) Filed: Feb. 16, 2020

(30) Foreign Application Priority Data
Feb. 28, 2019 (JP) 2019-035165

(51) Int. Cl. B01D 29/03; B01D 35/30; F15B 21/041

(52) U.S. Cl. CPC B01D 29/03; F15B 21/041; B01D 35/30

(57) ABSTRACT

A pressure control device includes: a body having groove-like channel containing a groove part and a widened part; a filter unit having a cylindrical frame formed of an elastic material and including a through hole part penetrating in a direction orthogonal to a central axis and a plate-shaped filter member disposed to cover the through hole part and supported on an inner side of the frame. The filter unit is accommodated in the widened part with a direction of the central axis of the frame being arranged along a depth direction of the widened part; and a separate plate installed to the body to cover the groove-like channel in a state in which the filter unit is accommodated in the widened part. The frame has a length along the central axis greater than a depth of the widened part.

### CROSS-REFERENCE TO RELATED APPLICATION

The present invention claims priority under 35 U.S.C. § 119 to Japanese Application No. 2019-035165 filed on Feb. 28, 2019 the entire content of which is incorporated herein by reference.

### BACKGROUND

### Technical Field

The disclosure relates to a pressure control device.

### Description of Related Art

As a hydraulic pressure control device that controls hydraulic pressure, for example, a hydraulic pressure control device provided for a clutch and mounted in an automobile is known.

It should be noted that the introduction in Background is merely provided for the convenience of clearly and comprehensively describing the technical solutions of the disclosure and facilitating the understanding of those skilled in the art. These technical solutions shall not be deemed well-known by those skilled in the art simply for having been described in Background.

However, in the hydraulic pressure control device recited in the conventional technology, there is a tendency that, as the channel becomes thinner, that is, as the width of the channel becomes smaller, the process of inserting the filter to the channel becomes more difficult to perform. Therefore, the issue that the process for assembling the body and the filter becomes less efficient may arise.

### SUMMARY

According to an aspect of the disclosure, a pressure control device includes: a body having groove-like channel containing a groove part and a widened part which is connected with the groove part and of which a width is increased from the groove part; a filter unit, which is a filter unit that captures a foreign matter mixed in a fluid passing through the groove-like channel and has a cylindrical frame formed of an elastic material and comprising a through hole part penetrating in a direction orthogonal to a central axis of the frame and a plate-shaped filter member disposed to cover the through hole part and supported on an inner side of the frame, wherein the filter unit is accommodated in the widened part with a direction of the central axis of the frame being arranged along a depth direction of the widened part; and a plate-like member installed to the body to cover the groove-like channel in a state in which the filter unit is accommodated in the widened part. The frame has a length along the central axis greater than a depth of the widened part.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is an oblique view illustrating a pressure control device according to an embodiment of the disclosure.

FIG. 2 is an exploded oblique view of the pressure control device shown in FIG. 1.

FIG. 3 is a cross-sectional view along III-III of FIG. 1.

FIG. 4 is a view illustrating the pressure control device of FIG. 1 from the front side.

FIG. 5 is an oblique view illustrating a longitudinal section of a portion of the pressure control device shown in FIG. 1.

FIG. 6 is a view of FIG. 5 when viewed from the top side.

FIG. 7 is a view illustrating a cross-sectional view along VI-VI of FIG. 5 (in a state in which a separate plate is installed to a body).

FIG. 8 is an exploded oblique view of the pressure control device shown in FIG. 5.

FIG. 9 is a cross-sectional view along VIII-VIII of FIG. 8.

### DESCRIPTION OF THE EMBODIMENTS

The foregoing and other features of the disclosure will become apparent from the following specification with reference to the accompanying drawings. Specific embodiments of the disclosure are disclosed in the specification and the accompanying drawings. The specification and the accompanying drawings describe several embodiments to which the principles of the disclosure are applicable. However, it should be understood that, the disclosure is not limited to the embodiments described herein, but shall include all modifications, variations and equivalents falling within the scope of the appended claims.

Hereinafter, a pressure control device of the disclosure will be described in detail based on preferred embodiments shown in the accompanying drawings. In the respective drawings, the Z-axis direction is set as a up-down direction Z. The X-axis direction is set as a left-right direction X among the horizontal directions orthogonal to the up-down direction Z. The Y-axis direction is set as an axis direction Y orthogonal to the left-right direction X among the horizontal directions orthogonal to the up-down direction Z. The positive side in the up-down direction Z is referred to as “upper side”, and the negative side is referred to as “lower side”. The positive side in the axis direction Y is referred to as “front side”, and the negative side is referred to as “rear side”. The front side is equivalent to one side of the axis direction, and the rear side is equivalent to the other side of the axis direction. In the embodiment, the depth direction of a groove part is set as the up-down direction, and the up-down direction is set as the Z-axis direction. In addition, the width direction of the groove part, which is orthogonal to the Z-axis direction, is set as the X-axis direction. Moreover, the length direction (longitudinal direction) of the groove part, which is orthogonal to the Z-axis direction and the X-axis direction respectively, that is, the flow direction of a flowing body, is set as the Y-axis direction. Therefore, “upper side”, “lower side”, “front side”, “rear side”, “up-down direction”, and “left-right direction” are merely terms for describing the relative position relationships of the respective parts. The actual arrangement relationship or the like may also be an arrangement relationship or the like other than the arrangement relationship indicated by these terms. In addition, “plan view” refers to a state of viewing the lower side from the upper side.

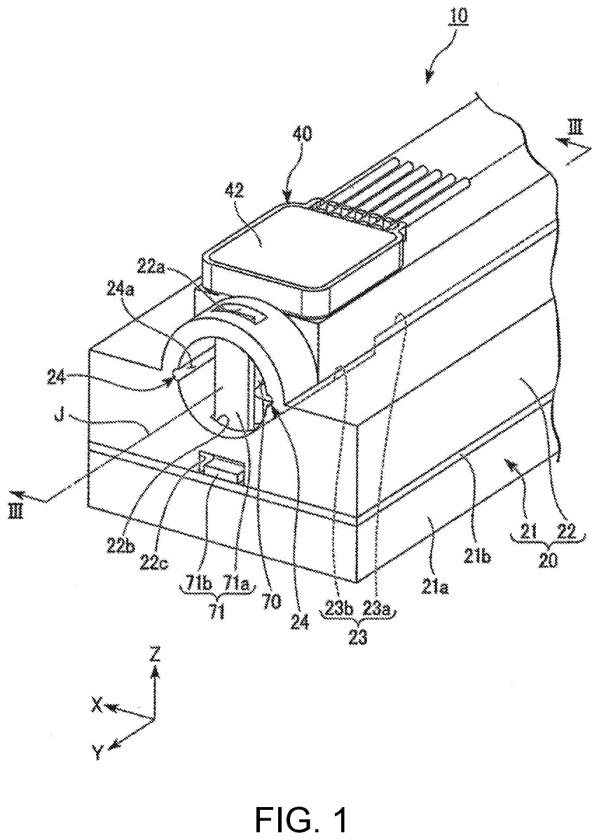

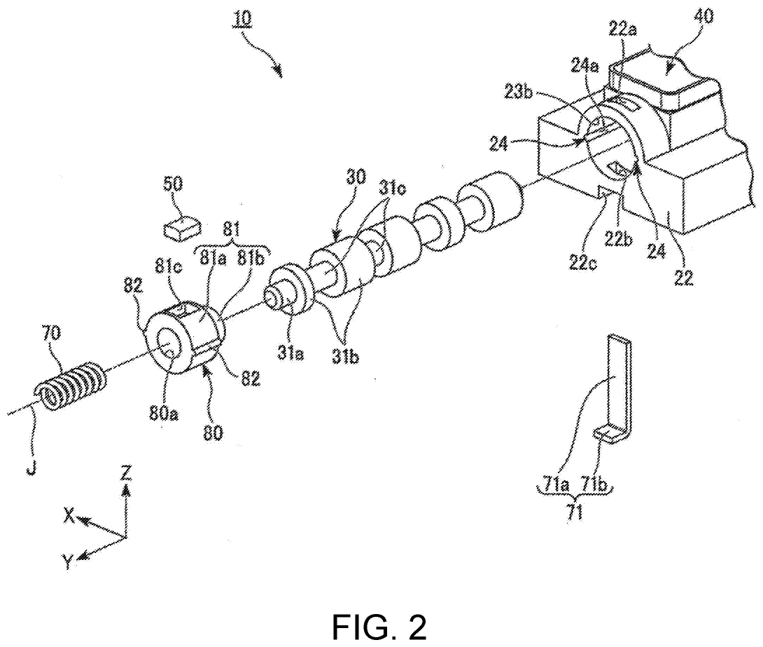

In addition, the embodiments of the pressure control device of the disclosure will be described with reference to FIGS. 1 to 9. A pressure control device 10 of the embodiment shown in FIG. 1 and FIG. 2 is, for example, a control valve mounted in a vehicle. The pressure control device 10 includes an oil channel body 20, a spool valve 30, a magnet holder 80, a magnet 50, an elastic member 70, a fixing member 71, and a sensor module 40.

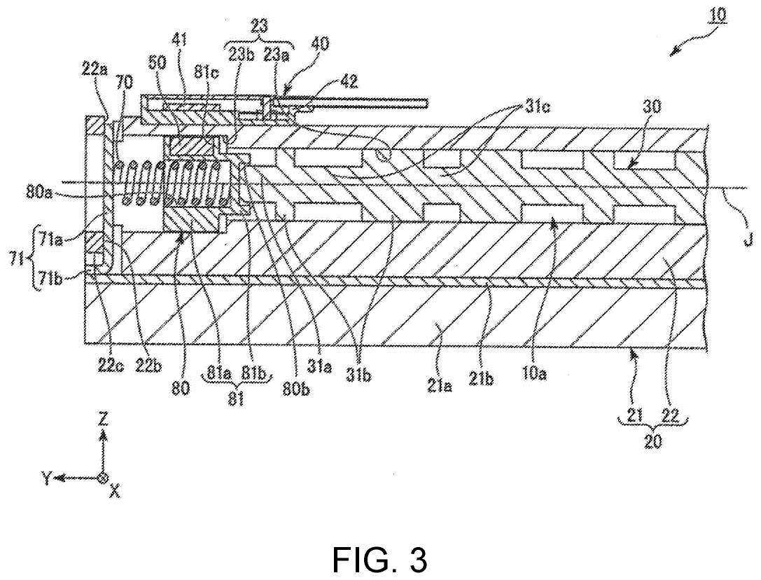

As shown in FIG. 3, the inside of the oil channel body 20 is provided with an oil channel 10a through which oil flows. A portion of the oil channel 10a indicated in FIG. 3 is a portion of a spool hole 23 described afterwards. In the respective drawings, for example, a state in which a portion of the oil channel body 20 is cut out is shown. As shown in FIG. 1, the oil channel body 20 has a lower body 21 and an upper body 22. While omitted in the drawings, the oil channel 10a is provided on both the lower body 21 and the upper body 22.

The lower body 21 has a lower body main body 21a and a separate plate 21b disposed to overlap the upper side of the lower body main body 21a. In the embodiment, the upper surface of the lower body 21 is equivalent to the upper surface of the separate plate 21b and is orthogonal to the up-down direction Z. The upper body 22 is disposed to overlap the upper side of the lower body 21. The lower surface of the upper body 22 is orthogonal to the up-down direction Z. The lower surface of the upper body 22 contacts the upper surface of the lower body 21, that is, the upper surface of the separate plate 21b.

As shown in FIG. 3, the upper body 22 has the spool hole 23 extending in the axis direction Y. In the embodiment, the shape of the section of the spool hole 23 orthogonal to the axis direction Y is a circular shape centering at a central axis J. The central axis J extends in the axis direction Y. A radial direction centering at the central axis J is simply referred to as “radial direction”, and a circumferential direction centering at the central axis J is simply referred to as “circumferential direction”.

The spool hole 23 at least opens on the front side. In the embodiment, the rear end of the spool hole 23 is closed. That is, the spool hole 23 is a hole that is open on the front side and has a bottom part. The spool hole 23, for example, may also open on two sides in the axis direction Y. At least a portion of the spool hole 23 forms a portion of the oil channel 10a inside the oil channel body 20.

The spool hole 23 has a spool hole main body 23a and a guiding hole part 23b. While omitted in the drawings, the oil channel 10a disposed at portions other than the spool hole 23 in the oil channel body 20 opens on the inner circumferential surface of the spool hole main body 23a. The inner diameter of the guiding hole part 23b is greater than the inner diameter of the spool hole main body 23a. The guiding hole part 23b is connected with the end part on the front side of the spool hole main body 23a. The guiding hole part 23b is the end part on the front side of the spool hole 23 and opens on the front side.

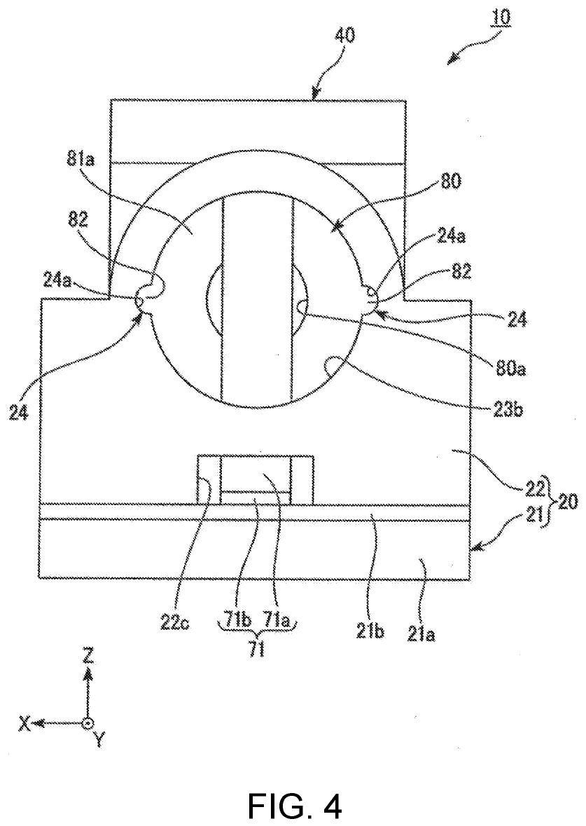

As shown in FIG. 1, the spool hole 23 has a groove part 24 that is recessed from the inner circumferential surface of the spool hole 23 to the radially outer side and extends along the axis direction Y. In the embodiment, a pair of groove parts 24 are provided to sandwich the central axis J. The pair of groove parts 24 are recessed from the inner circumferential surface of the guiding hole part 23b toward the two sides of the left-right direction X. The groove part 24 is provided from the end part on the front side on the inner circumferential surface of the guiding hole part 23b till the end part on the rear side on the inner circumferential surface of the guiding hole part 23b. As shown in FIG. 4, an inner side surface 24a of the groove part 24, when viewed from the front side, is in a semi-circular shape concave from the inner circumferential surface of the guiding hole part 23b to the radially outer side.

As shown in FIG. 3, the upper body 22 has through holes 22a, 22b, and 22c at the end part on the front side of the upper body 22. The through hole 22a penetrates, in the up-down direction Z, a portion from the upper surface of the upper body 22 till the inner circumferential surface of the guiding hole part 23b in the upper body 22. The through hole 22b penetrates, in the up-down direction Z, a portion from the lower surface of the upper body 22 till the inner circumferential surface of the guiding hole part 23b in the upper body 22. As shown in FIG. 1, when viewed from the top side, the through hole 22a and the through hole 22b are in a rectangular shape that is elongated in the left-right direction X. When viewed from the top side, the through hole 22a and the through hole 22b are overlapped with each other.

As shown in FIG. 3, the through hole 22c penetrates, in the axis direction Y, a portion from the front surface of the upper body 22 till the through hole 22b in the upper body 22. The through hole 22c is provided at the lower end part on the front surface of the upper body 22. The through hole 22c opens on the lower side. As shown in FIG. 4, when viewed from the front side, the through hole 22c is in a rectangular shape that is elongated in the left-right direction X. The centers of the through holes 22a, 22b, and 22c in the left-right direction X are, for example, at the same position as the central axis J in the left-right direction X.

As shown in FIG. 1, the portion in which the spool hole 23 is provided in the upper body 22 protrudes toward the upper side with respect to other portions of the upper body 22. In the protruding portion, the upper surface at the end part on the front side is a curved surface that is in a semi-circular shape that protrudes toward the upper side. The through hole 22a opens at the upper end part of the semi-circular curved surface. The lower body main body 21a, the separate plate 21b, and the upper body 22 are, for example, respectively individual components. The lower body main body 21a, the separate plate 21b, and the upper body 22 are made of non-magnetic bodies.

As shown in FIG. 3, the spool valve 30 is disposed along the central axis J extending in the axis direction Y intersecting the up-down direction Z. The spool valve 30 is in a columnar shape. The spool valve 30 is attached to the oil channel body 20. The spool valve 30 is movably disposed inside the spool hole 23 in the axis direction Y.

The spool valve 30 moves inside the spool hole body 23a in the axis direction Y to open and close the opening part of the oil channel 10a that opens on the inner circumferential surface of the spool hole body 23a. While not shown in the drawings, at the end part on the rear side of the spool valve 30, a forward force is applied from the hydraulic pressure of the oil or a driving device such as a solenoid actuator, etc. The spool valve 30 has a support part 31a, a plurality of large diameter parts 31b, and a plurality of small diameter parts 31c. The respective parts of the spool valve 30 are in a columnar shape centering at the central axis J and extending in the axis direction Y.

The support part 31a is the end part on the front side of the spool valve 30. The end part on the front side of the support part 31a supports the end part on the rear side of the magnet holder 80. The end part on the rear side of the support part 31a is connected with the end part on the front side of the large diameter part 31b.

The large diameter parts 31b and the small diameter parts 31c are alternately and continuously disposed from the large diameter part 31b connected with the end part on the rear side of the support part 31a toward the rear side. The outer diameter of the large diameter part 31b is greater than the outer diameter of the small diameter part 31c. In the embodiment, the outer diameter of the support part 31a and the outer diameter of the small diameter part 31c are, for example, the same. The outer diameter of the large diameter part 31b is about the same as the inner diameter of the spool hole body 23a and is only slightly smaller than the inner diameter of the spool hole body 23a. The large diameter part 31b is able to move in the axis direction Y while sliding with respect to the inner circumferential surface of the spool hole body 23a. The large diameter part 31b functions as a valve part that opens and closes the opening part of the oil channel 10a opening on the inner circumferential surface of the spool hole body 23a. In the embodiment, the spool valve 30 is, for example, an individual component made of metal.

The magnet holder 80 is disposed on the front side of the spool valve 30. The magnet holder 80 is disposed to be movable in the axis direction Y inside the guiding hole part 23b. The spool valve 30 and the magnet holder 80 are allowed to rotate relative to each other about the central axis. As shown in FIG. 2, the magnet holder 80 has a holder body part 81 and an opposing part 82.

The holder body part 81 is in a stepped columnar shape centering at the central axis J and extending in the axis direction Y. As shown in FIG. 3, the holder body part 81 is disposed inside the spool hole 23. More specifically, the holder body part 81 is disposed inside the guiding hole part 23b. The holder body part 81 has a sliding part 81a and a supported part 81b. That is, the magnet holder 80 has the sliding part 81a and the supported part 81b.

The outer diameter of the sliding part 81a is greater than the outer diameter of the large diameter part 31b. The outer diameter of the sliding part 81a is about the same as the inner diameter of the guiding hole part 23b and is only slightly smaller than the inner diameter of the guiding hole part 23b. The sliding part 81a is able to move in the axis direction Y while sliding with respect to the inner circumferential surface of the spool hole 23, that is, the inner circumferential surface of the guiding hole part 23b in the embodiment. The radially outer edge part of the surface on the rear side of the sliding part 81a is able to contact a step surface toward the front side which generates a step difference between the spool body part 23a and the guiding hole part 23b. In this way, the movement of the magnet holder 80 from the position at which the magnet holder 80 contacts the step surface toward the rear side can be suppressed and the rearmost position of the magnet holder 80 can be determined. Since the spool valve 30 receives a force toward the rear side from the elastic member 70 via the magnet holder 80, as will be described afterwards, by determining the rearmost position of the magnet holder 80, the rearmost position of the spool valve 30 can be determined.

The supported part 81b is connected with the end part on the rear end of the sliding part 81a. The outer diameter of the supported part 81b is smaller than the outer diameter of the sliding part 81a and the outer diameter of the large diameter part 31b, and is greater than the outer diameter of the support part 31a and the outer diameter of the small diameter part 31c. The supported part 81b is movable inside the spool hole body 23a. The supported part 81b, together with the movement of the spool valve 30 in the axis direction Y, moves in the axis direction Y between the guiding hole part 23b and the spool hole body 23a.

The supported part 81b has a supported concave part 80b that is recessed from the end part on the rear end of the supported part 81b to the front side. The support part 31a is inserted into the supported concave part 80b. The end part on the front end of the support part 31a contacts the bottom surface of the supported concave part 80b. In this way, the magnet holder 80 is supported from the rear side by the spool valve 30. The size of the supported part 81b in the axis direction Y is, for example, smaller than the size of the sliding part 81a in the axis direction Y.

As shown in FIG. 2, the opposing part 82 protrudes from the holder body part 81 to the radially outer side. More specifically, the opposing part 82 protrudes from the sliding part 81a to the radially outer side. In the embodiment, a pair of opposing parts 82 are provided to sandwich the central axis J. The pair of opposing parts 82 protrude from the outer circumferential surface of the sliding part 81 to the two sides of the left-right direction X. The opposing part 82 extends in the axis direction Y from the end part on the front end side of the sliding part 81a till the end part on the rear side of the sliding part 81a. As shown in FIG. 4, the opposing part 82, when viewed from the front side, is in a semi-circular shape convex toward the radially outer side.

The pair of opposing parts 82 are fit with the pair of groove parts 24. The opposing part 82 is opposite to the inner side surface 24a of the groove part 24 and is able to contact the inner side surface 24a. The description “two parts are opposite in the circumferential direction” in the specification may be construed as both of the two parts being located along the circumferential direction on a hypothetical circle and opposite to each other.

As shown in FIG. 3, the magnet holder 80 has a first concave part 81c that is recessed from the outer circumferential surface of the sliding part 81a to the radially inner side. In FIG. 3, the first concave part 81c is recessed from the upper end part of the sliding part 81a toward the lower side. The inner side surface of the first concave part 81c includes a pair of surfaces opposite to each other in the axis direction Y.

The magnet holder 80 has a second concave part 80a recessed from the end part on the front side in the magnet holder 80 to the rear side. The second concave part 80a extends from the sliding part 81a till the supported part 81b. As shown in FIG. 2, the second concave part 80a, when viewed from the front side, is in a circular shape centering at the central axis J. As shown in FIG. 3, the inner diameter of the second concave part 80a is greater than the inner diameter of the supported concave part 8.

The magnet holder 80, for example, may be made of resin or metal. In the case where the magnet holder 80 is made of resin, the magnet holder 80 can be easily manufactured. In addition, the manufacturing cost of the magnet holder 80 can be reduced. In the case where the magnet holder 80 is made of metal, the size accuracy of the magnet holder 80 can be increased.

As shown in FIG. 2, the magnet 50 is substantially in a rectangular parallelepiped shape. The upper surface of the magnet 50 is, for example, a curved surface in a circular shape along the circumferential direction. As shown in FIG. 3, the magnet 50 is accommodated inside the first concave part 81c and fixed to the holder main body 81. In this way, the magnet 50 is fixed to the magnet holder 80. The magnet 50 is, for example, fixed by an adhesive. The radially outer surface of the magnet 50 is, for example, located radially inward with respect to the outer circumferential surface of the sliding part 81a. The radially outer surface of the magnet 50 is opposite to the inner circumferential surface of the guiding hole part 23b via a gap in the radial direction.

As described above, the sliding part 81a provided in the first concave part 81c moves while sliding with respect to the inner circumferential surface of the spool hole 23. Therefore, the outer circumferential surface of the sliding part 81a and the inner circumferential surface of the spool hole 23 contact each other or opposite to each other via a small gap. In this way, it is difficult for foreign matters, such as metal pieces, included in the oil to enter the first concave part 81c. Therefore, the foreign matters, such as metal pieces, included in the oil can be suppressed from being attached to the magnet 50 accommodated in the first concave part 81c. Since the size accuracy of the sliding part 81a can be increased in the case where the magnet holder 80 is made of metal, it is even more difficult for foreign matters, such as metal pieces, included in the oil to enter the first concave part 81c.

As shown in FIG. 2, the fixing member 71 is a plate surface in a plate shape parallel to the left-right direction X. The fixing member 71 has an extending part 71a and a bent part 71b. The extending part 71a extends in the up-down direction Z. The extending part 71a, when viewed from the front side, is in a rectangular shape that is elongated in the up-down direction Z. As shown in FIG. 1 and FIG. 3, the extending part 71a is inserted into the guiding hole part 23b via the through hole 22b. The upper end part of the extending part 71a is inserted into the through hole 22a. The extending part 71a blocks a portion of the opening on the front side of the guiding hole part 23b. The bent part 71b is bent from the end part on the lower side of the extending part 71a to the front side. The bent part 71b is inserted into the through hole 22c. The fixing member 71 is disposed on the front side of the elastic member 70.

In the embodiment, the fixing member 71 is inserted from the opening part of the through hole 22b that opens on the lower surface of the upper body 22 to the through hole 22a via the through hole 22b and the guiding hole part 23b before the upper body 22 and the lower body 21 are overlapped. Then, as shown in FIG. 1, by stacking in the up-down direction Z to assemble the upper body 22 and the lower body 21, the bent part 71b inserted into the through hole 22c is supported from the lower side by the upper surface of the lower body 21. In this way, the fixing member 71 can be attached to the oil channel body 20.

As shown in FIG. 3, the elastic member 70 is a coil spring extending in the axis direction Y. The elastic member 70 is disposed on the front side of the magnet holder 80. In the embodiment, at least a portion of the elastic member 70 is disposed inside the second concave part 80a. Therefore, at least a portion of the elastic member 70 can be overlapped with the magnet holder 80 in the radial direction, and the size of the pressure control device 10 in the axis direction Y can be easily miniaturized. In the embodiment, the portion on the rear side of the elastic member 70 is disposed inside the second concave part 80a.

The end part on the rear side of the elastic member 70 contacts the bottom surface of the second concave part 80a. The end part on the front side of the elastic member 70 contacts the fixing member 71. In this way, the end part on the front side of the elastic member 70 is supported by the fixing member 71. The fixing member 71 receives an elastic force from the elastic member 70 toward the front side, and the extending part 71a is pressed to the inner side surface on the front side of the through holes 22a and 22b.

With the end part on the front side of the elastic member 70 being supported to the fixing member 71, the elastic member 70 applies an elastic force toward the rear side to the spool valve 30 via the magnet holder 80. Therefore, for example, the position of the spool valve 30 in the axis direction Y can be maintained at a position where the hydraulic pressure of the oil applied to the end part on the rear side of the spool valve 30 or the force applied from a driving device such as a solenoid actuator balances the elastic force of the elastic member 70. In this way, by changing the force applied to the end part on the rear side of the spool valve 30, the position of the spool valve 30 in the axis direction Y can be changed, and the on/off of the oil channel 10a inside the oil channel body 20 can be switched.

In addition, with the hydraulic pressure of the oil applied to the end part on the rear side of the spool valve 30 or the force applied from a driving device such as a solenoid actuator, as well as the elastic force of the elastic member 70, the magnet holder 80 and the spool valve 30 can be pressed against each other in the axis direction Y. Therefore, the magnet holder 80 allows relative rotation with respect to the spool valve 30 about the central axis and moves in the axis direction Y together with the movement of the spool valve 30 in the axis direction Y.

The sensor module 40 has a housing 42 and a magnetic sensor 41. The housing 42 accommodates the magnetic sensor 41. As shown in FIG. 1, the housing 42 is, for example, in a rectangular box shape flat in the up-down direction Z. The housing 42 is fixed on a flat surface, in the upper surface of the upper body 22, located on the rear side of the semi-circular shaped curved surface on which the through hole 22a is provided.

As shown in FIG. 3, the magnetic sensor 41 is fixed to the bottom surface of the housing 42 inside the housing 42. In this way, the magnetic sensor 41 is attached to the oil channel body 20 via the housing 42. The magnetic sensor 41 detects a magnetic field of the magnet 50. The magnetic sensor 41 is, for example, a Hall element. The magnetic sensor 41 may also be a magnetic resistance element.

As the position of the magnet 50 in the axis direction Y changes with the movement of the spool valve 30 in the axis direction Y, the magnetic field of the magnet 50 passing through the magnetic sensor 41 changes. Therefore, by detecting changes of the magnetic field of the magnet 50 by the magnetic sensor 41, the position of the magnet 50 in the axis direction Y, that is, the position of the magnet holder 80 in the axis direction Y, can be detected. Accordingly, as described above, the magnet holder 80 moves in the axis direction Y together with the movement of the spool valve 30 in the axis direction Y. Therefore, by detecting the position of the magnet holder 80 in the axis direction Y, the position of the spool valve 30 in the axis direction Y can be detected.

The magnetic sensor 41 and the magnet 50 are overlapped in the up-down direction Z. That is, at least a portion of the magnet 50 overlaps the magnetic sensor 41 in a direction parallel to the up-down direction Z in the radial direction. Therefore, the magnetic field of the magnet 50 is easily detected by the magnetic sensor 41. Therefore, with the sensor module 40, the position change of the magnet holder 80 in the axis direction Y, that is, the position change of the spool valve 30 in the axis direction Y, can be more accurately detected.

The description “at least a portion of the magnet overlaps the magnetic sensor in the radial direction” in the specification indicates that it is acceptable as long as at least a portion of the magnet overlaps the magnetic sensor in the radial direction in the position of at least a portion within the range in which the spool valve to which the magnet is directly fixed moves in the axis direction. That is, for example, when the spool valve 30 and the magnet holder 80 change the positions in the axis direction Y from the positions of FIG. 3, it may also be that the magnet 50 does not overlap the magnetic sensor 41 in the up-down direction Z. In the embodiment, if the magnet 50 is within the range in which the spool valve 30 moves in the axis direction Y, at any position, a portion of the magnet 50 overlaps the magnetic sensor 41 in the up-down direction.

The pressure control device 10 includes a rotation stopping part. The rotation stopping part is a portion able to contact the magnet holder 80. In the embodiment, the rotation stopping part is the inner side surface 24a of the groove part 24. That is, the opposing part 82 is opposite to the inner side surface 24a, which is the rotation stopping part, in the circumferential direction and is able to contact the inner side surface 24a.

Therefore, according to the embodiment, for example, in the case where the opposing part 82 rotates about the central axis J, the opposing part 82 contacts the inner side surface 24a which is the rotation stopping part. In this way, the rotation of the opposing part 82 is suppressed by the inner side surface 24a, and the rotation of the magnet holder 80 about the central axis J is suppressed. Therefore, the deviation of the position of the magnet 50 fixed to the magnet holder 80 in the circumferential direction can be suppressed. Consequently, in the case where the position of the spool valve 30 in the axis direction Y does not change, even if the spool valve 30 rotates about the central axis J, the changes of the position information of the magnet 50 in the axis direction Y that is detected by the magnetic sensor 41 can be suppressed. In this way, the changes of the position information of the spool valve 30 can be suppressed, and the accuracy for grasping the position of the spool valve 30 in the axis direction Y can be increased.

In the embodiment, the rotation stopping part is the inner side surface 24a of the groove part 24. Therefore, it is not necessary to prepare a separate component as the rotation stopping part, and the number of parts of the pressure control device 10 can be reduced. In this way, the work required to assemble the pressure control device 10 and the manufacturing cost of the pressure control device 10 can be reduced.

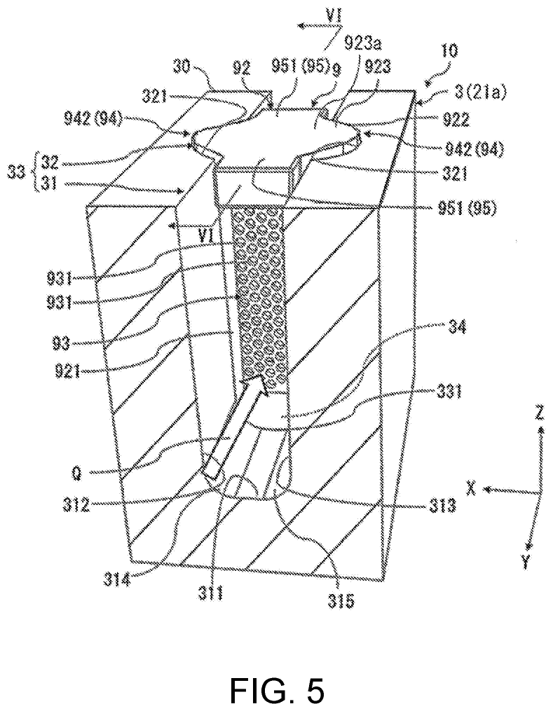

As described above, there are cases in which the oil passing through the pressure control device 10 contains foreign matters such as metal pieces. It is preferable that such foreign matters are captured in the process in which the oil passes through the pressure control device 10 and are prevented from further flowing to the downstream side. Here, the pressure control device 10 is configured to be able to capture foreign matters. In the following, the configuration and the function are described with reference to FIG. 5 to FIG. 9.

While the pressure control device 10 is suitable for a hydraulic pressure control device controlling the pressure of the oil in the embodiment, the pressure control device 10 is not limited thereto. Examples of devices for which the pressure control device 10 is suitable include, for example, in addition to the hydraulic pressure control device, fluid devices such as a water pressure control device that controls the pressure of water and an air pressure control device that controls the pressure of air. In such case, those passing through the pressure control device 10 are fluids such as oil, water, air, and are generally referred to as “fluid” in the following descriptions. In addition, the direction in which the fluid flows is referred to as “flowing direction Q”.

The pressure control device 10, as shown in FIG. 5, further includes a filter unit 9 attached to a body 3 in addition to the spool valve 30, the magnet holder 80, the magnet 50, the elastic member 70, the fixing member 71, the sensor module 40, etc., as described above.

The body 3 can be at least one of the lower body 21 and the upper body 22 forming the oil channel 20. As shown in FIGS. 5 to 7, the body 3 has a groove-like channel 30 which is recessed on the upper surface (a surface) 30 and through which the fluid passes through along the flowing direction Q. The groove-like channel 33 contains a groove part 31 and a widened part 32 connected with the groove part 31, and forms a portion of the oil channel 10a.

The groove part 31 has a bottom part (first bottom part) 311, a sidewall part 312 located on one side of the bottom part 311 when viewed from the upstream toward the downstream of the flow of the fluid, and a sidewall part 313 located on the other side of the bottom part 311. A border part 314 of the bottom part 311 and the sidewall part 312 as well as a border part 315 of the bottom part 311 and the sidewall part 313 are preferably arced, as shown in FIG. 5. In this way, the fluid can smoothly pass through the vicinity of the border part 314 and the border part 315.

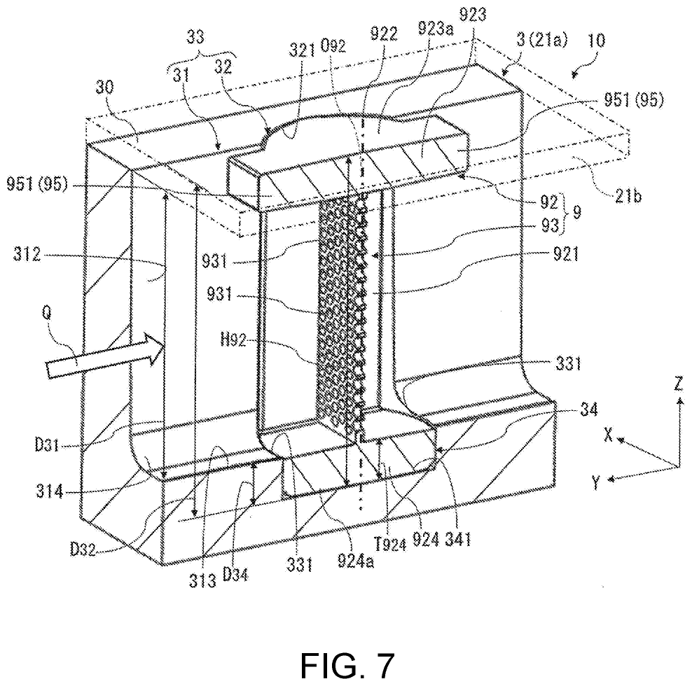

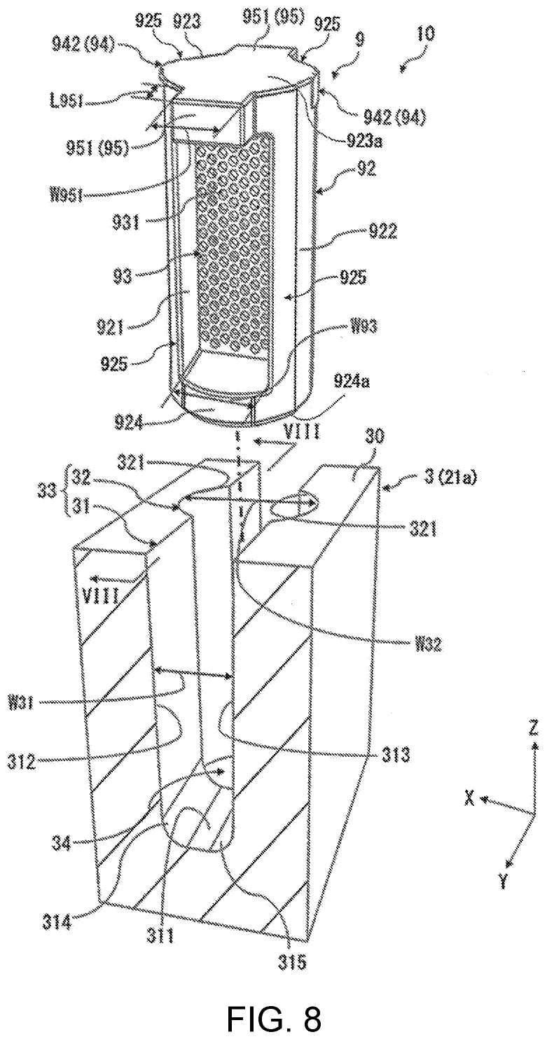

While the groove part 31 is in a linear shape along the axis direction Y in the plan view of the body 3, the disclosure is not limited thereto. It may also be that the groove part 31 has a part in which at least a portion thereof is curved. A width (first width) W₃₁ (referring to FIG. 8) of the groove part 31, which is the interval between the sidewall part 312 and the sidewall part 313 is approximately constant along the axis direction Y. In addition, a depth (first depth) D₃₁ (referring to FIG. 7) of the groove part 31, which is the depth from the surface 30 to the bottom part 311, is also approximately constant along the axis direction Y.

The widened part 32 is disposed on the longitudinal direction of the groove-like channel 33, that is, on the axis direction Y. The width of the widened part 32 is greater than the width W₃₁ of the groove part 31 from the surface 30 till the bottom part 311, and the widened part 32 functions as an accommodating part accommodating the filter unit 9 that is cylindrical. A width W32 (referring to FIG. 8) of the widened part 32 is gradually increased from the upstream side toward the downstream side, that is, from the front side toward the rear side, and becomes gradually decreased toward the downstream side from the middle. Specifically, in the embodiment, the widened part 32 has a curved part 321 that is curved in a circular shape in the plan view. The widened part 32 in such shape can, for example, be processed by using an end mill.

As shown in FIG. 7, the width W₃₂ of the widened part 32 is maintained constant along the up-down direction Z, and a depth (second depth) D₃₂ from the surface 30 till a bottom surface (second bottom part) 341 becomes greater than the depth D₃₁ of the groove part 31. The bottom part of the widened part 32 has a receiving part 34 into which a portion of the lower side of the filter unit 9 is inserted. Of course, the depth D₃₄ of the receiving part 34 is equal to the difference between the depth D₃₂ and the depth D₃₁.

As shown in FIGS. 5 and 7, the filter unit 9 is accommodated in the widened part 32 with the direction of a central axis O₉₂ of a frame 92 being arranged along the direction of the depth D₃₂ of the widened part 32 (that is, the up-down direction Z). When the fluid passes through the groove-like channel 33, the filter unit 9 can capture foreign matters mixed in the fluid. In this way, the filter unit 9 can prevent or suppress malfunctioning of the operation of the pressure control device 10 due to foreign matters. Examples of the malfunctioning include the obstruction of movement when the spool valve 30 moves in the spool hole 23, etc.

The filter unit 9 has the cylindrical frame 92 and a filter member 93 that is plate-shaped and disposed on the inner side of the frame 92. The filter member 93 is disposed along the direction of the central axis O₉₂ of the frame 92, and the thickness direction thereof is parallel to the axis direction Y. In this way, the filter member 93 can face the fluid passing through the groove-like channel 33.

The filter member 93 has a plurality of pores 931 penetrating in the thickness direction. The pores 931 are disposed at intervals along the left-right direction X as well as the up-down direction Z. The diameter of the pore 931 is set to be smaller than the diameter of an average foreign matter. In addition, in order not to obstruct the flow of the fluid, the total area of the pores 931 is preferably as great as possible, and the aperture ratio is also preferably as great as possible. With such pores 931, the performance of capturing foreign matters by the filter unit 9 can be facilitated.

In addition, the filter member 93 is in a state of being supported on the inner side of the frame 92. In this way, when the fluid passes through the filter member 93, the filter member 93 is prevented from being deformed by the flow of the fluid. Thus, the foreign matters can be reliably captured by the filter member 93. As a result, the performance of capturing foreign matters by the filter unit 9 can be further facilitated.

As shown in FIG. 8, a width W₉₃ of the filter member 93 is the same as the width W₃₁ of the groove part 31 located upstream of the widened part 32. In this way, when the fluid passes through the filter member 93, the capturing area in which the filter member 93 captures foreign matters can be ensured to be wide as possible. Consequently, the performance of capturing foreign matters by the filter unit 9 can be further facilitated. While the width W₉₃ is the same as the width W₃₁ in the embodiment, the disclosure is not limited thereto. For example, the width W₃₁ may also be greater.

As shown in FIG. 7, the frame 92 is cylindrical and includes a through hole part 921 penetrating in parallel with the axis direction Y orthogonal to the central axis O₉₂ of the frame 92. While the external shape of the frame 92 is cylindrical in the embodiment, the disclosure is not limited thereto. The external shape of the frame 92 may also be rectangular cylindrical. Then, the filter member 93 is disposed to cover the through hole part 921 and is supported on the inner side of the frame 92. In this way, the filter member 93 and the frame 92 are unitized and configured as one part, that is, the filter unit 9. Here, the inner side of the frame 92 refers to the side facing the through hole part 921, and the outer side of the frame 92 refers to the side facing the body 3 and the separate plate 21b.

At the time of assembling the body 3 and the filter unit 9, the assembling can be performed by simply inserting the filter unit 9 into the widened part 32. In addition, as described above, the widened part 32 is wider than the groove part 31. In this way, regardless of the size of the width W₃₁ of the groove part 31, the filter unit 9 can be easily inserted into the widened part 32. Thus, the workability at the time of assembling the body 3 and the filter unit 9 is improved.

As shown in FIG. 8, since the frame 92 is cylindrical, as described above, an outer circumferential part 922 of the frame 92 is arced in a circular shape. Meanwhile, in the widened part 32 accommodating the filter unit 9, the curved shape of the curved part 321 is curved along the circular arc of the outer circumferential part 922. In this way, at the time of assembling the body 3 and the filter unit 9, the filter unit 9 can be easily inserted into the widened part 32.

In addition, the cylindrical frame 92 has the outer circumferential part (torso part) 922, a closed wall part 923 closing the upper side in the direction of the central axis O₉₂ of the outer circumferential part 922, and a closed wall part 924 closing the lower side. In the state in which the filter unit 9 is accommodated in the widened part 32, a portion of the lower side of the filter unit 9, that is, the closed wall part 924 of the closed wall part 923 and the closed wall part 924, can be inserted into the receiving part 34. In the disclosure, the frame 92 is formed of an elastic material.

As shown in FIG. 5, in the state of being accommodated in the widened part 32, the frame 92 (the filter unit 9) has a height to an extent of slightly protruding from the groove-like channel 30 toward the upper side. That is, a length H₉₂ (a distance from an upper surface 923a till a lower surface 924a of the frame 92) along the central axis O₉₂ of the frame 92 is greater than the depth D₃₂ of the widened part 32. Therefore, in the state in which the filter unit 9 is accommodated in the widened part 32, when the separate plate (plate-like member) 21b is installed to the body 3 (the lower body main body 21a) to cover the groove-like channel 33, the frame 92 are elastically deformed. In this way, the upper surface 923a of the frame 92 (the closed wall part 923) closely contacts the lower surface of the separate plate 21b, and the lower surface 924a of the frame 92 (the closed wall part 924) closely contacts the bottom surface 341 of the widened part 32 (the receiving part 34). Thus, the fluid preferentially and smoothly passes through the through hole part 921 of the frame 92. Accordingly, the property of capturing foreign matters by the filter member 93 can be properly exhibited. In the state in which the separate plate 21b is installed to the body 3, as shown in FIG. 7, the height (the length of the frame 92 along the central axis O₉₂) H₉₂ of the frame 92 is about as large as the depth D₃₂ of the widened part 32.

As described above, the pressure control device 10 is formed by inserting the closed wall part 924 of the filter unit 9 into the receiving part 34 of the widened part 32. In other words, in the pressure control device 10, a step difference 331 is created between (borders of) the bottom part 311 of the groove part 31 and the bottom surface 341 of the receiving part 34, and the closed wall part 924 is disposed to resolve the step difference 331. In this way, it becomes substantially difficult to generate a fluid flowing to bypass between the closed wall part 924 and the receiving part 34. Therefore, the foreign matters can be prevented from flowing through the filter unit 9 to the downstream side. Since the frame 92 is formed of an elastic material, the closed wall part 924 can be elastically deformed to closely contact the receiving part 34.

A thickness T₉₂₄ of the closed wall part 924 after elastic deformation is approximately the same as the depth D₃₄ of the receiving part 34. In this way, it is difficult to create a step difference between the bottom part 311 of the groove part 31 and the closed wall part 924. Therefore, the fluid can smoothly pass through the filter unit 9. In addition, since the fluid can smoothly pass through, it is even more difficult to generate a flow of the fluid that bypasses between the closed wall part 924 and the receiving part 34. In this way, the foreign matters can be more reliably prevented from flowing through the filter unit 9 to the downstream side.

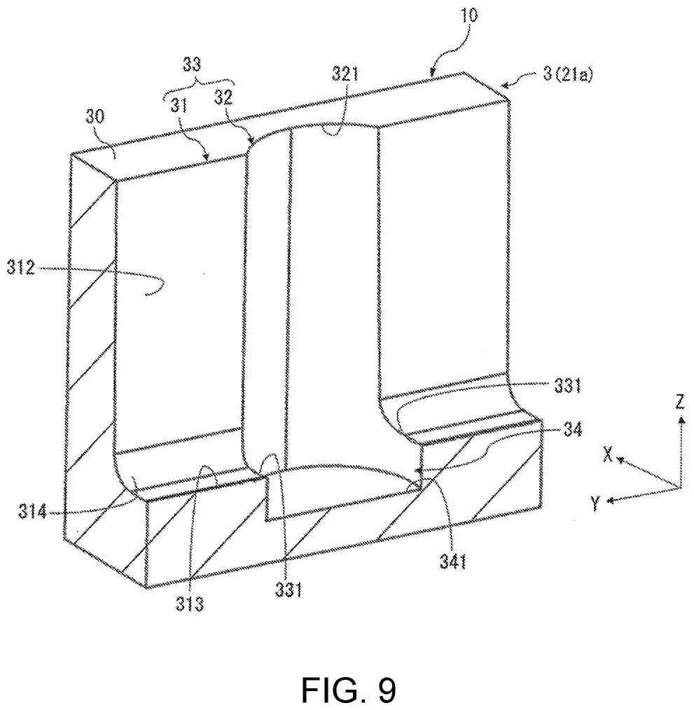

Particularly, in the embodiment, the upper surface 923a and the lower surface 924a of the frame 92 (the end surfaces on two sides in the direction of the central axis O₉₂ of the frame 92) are flat surfaces and, as shown in FIG. 9, the receiving part 34 has the bottom surface 341 that is flat. Then, as shown in FIG. 7, in the state in which the filter unit 9 is accommodated in the widened part 32 and the separate plate 21b is installed to the upper surface 30 of the body 3, the entirety of the upper surface 923a of the frame 92 contacts the lower surface of the separate plate 21b, and the entirety of the lower surface 924a of the frame 92 contacts the bottom surface 341 of the widened part 32. In this way, even in the state in which the fluid passes through the groove-like channel 33, the posture of the filter unit 9 inside the widened part 32 is stable, so the filter unit 9 can stably capture foreign matters.

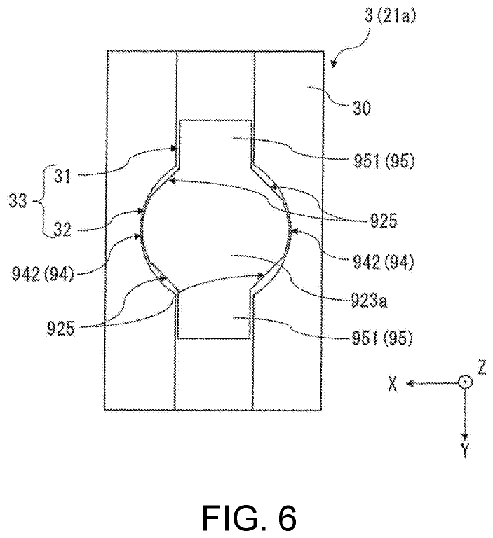

In addition, as shown in FIGS. 5 and 6, the frame 92 is provided with concave parts 925 on the upstream side and the downstream side, respectively. The concave part 925 is a portion where the outer circumferential part 922 of the frame 92 is concave along the up-down direction Z and toward the side of the through hole part 921. In other words, the concave part 925 is also a thin part (diameter reduced part) in which the thickness of the frame 92 in the radial direction is reduced along the top-down direction Z. The concave part 925 functions as a deformation absorbing part absorbing deformation of the frame 92. Therefore, when the filter unit 9 is accommodated in the widened part 32 and the separate plate 21b is installed to the body 3, the frame 92 is elastically deformed so as to fill the gap between the concave part 925 and the widened part 32. In this way, by making the outer circumferential part 922 of the frame 92 the shape along the inner circumferential surface of the widened part 32, the tightness therebetween is facilitated. As result, the fluid can be more reliably prevented from flowing to the downstream side by passing through the lateral side of the frame 92.

As shown in FIGS. 5 to 7, the filter unit 9 has a regulating part 95, which, in the state in which the filter unit 9 is accommodated in the widened part 32, regulates the arrangement direction with respect to the groove part 31 and prevents the filter unit 9 from rotating about the central axis O₉₂. The regulating part 95 is formed by a pair of protruding parts 951 disposed to protrude as a block or a plate on the closed sidewall part 923. One of the protruding parts 951 protrudes toward the groove part 31 located on the upstream side of the widened part 32, that is, the front side in the axis direction Y, and the other protruding part 951 protrudes toward the groove part 31 located on the downstream side of the widened part 32, that is, the rear side of the axis direction Y.

It may also be that the regulating part 95 does not have the pair of protruding parts 951. For example, one of the protruding parts 951 may be omitted. In addition, it is preferable that a width W₉₅₁ of each of the protruding parts 951 is slightly smaller than the width W₃₁ of the groove part 31.

Then, in the state in which the filter unit 9 is accommodated in the widened part 32, each of the protruding parts 951 is disposed in the groove part 31. In addition, at this time, there is also a case in which each of the protruding parts 951 abuts against at least one of the sidewall part 312 and the sidewall part 313 of the groove part 31. With such protruding parts 951, in the state of being accommodated in the widened part 32, the arrangement direction of the filter unit 9 with respect to the groove part 31 is correctly regulated, so as to avoid the rotation about the central axis O₉₂. In this way, regardless the size of the flow of the fluid, the filter member 93 can face the flowing direction Q of the fluid, and thus can stably capture foreign matters.

In addition, the regulating part 95 can be formed by the protruding parts 951 whose shape is simple, thereby contributing to the high efficiency at the time of manufacturing the filter unit 9. In addition, by disposing the regulating part 95 at the closed wall part 923 of the frame 92, the regulating part 95 can be disposed as close to the corner of the groove-like channel 33 as possible. Accordingly, the regulating part 95 can be prevented or suppressed from obstructing the flow of the fluid.

As shown in FIG. 5, the filter unit 9 has a detachment preventing part 94 that prevents the filter unit 9 from being detached from the widened part 32 after being inserted to the widened part 32. The detachment preventing part 94 is configured to include a pair of flat protruding parts 942 which are disposed to protrude on the closed wall part 923 of the frame 92 and are in a flat shape. As shown in FIG. 8, one of the flat protruding parts 942 protrudes toward the left side of the left-right direction X, and the other flat protruding part 942 protrudes toward the right side of the left-right direction X. Then, in the state in which the filter unit 9 is accommodated in the widened part 32, each of the flat protruding parts 942 is pressed against the widened part 32 in the protruding direction of the flat protruding part 942. In this way, the filter unit 9 can be prevented from being detached from the widened part 32. In the following, the effect resulting from the detachment preventing part 94 may be referred to as “detachment preventing effect”. With the detachment preventing effect, for example, even if the body 3 and the filter unit 9 in the assembled state are turned upside down or is subjected to vibration during transportation, the detachment of the filter unit 9 from the widened part 32, which unintentionally decomposes the body 3 and the filter unit 9, can be prevented.

In the filter unit 9 with the above configuration, for example, it is preferable that the frame 92 is formed of an elastic material (rubber material), and the filter member 93 is formed of a metal material. In this way, the filter unit 9 can be an insert molded product of the frame 92 and the filter member 93. In this way, a higher efficiency at the time of manufacturing the filter unit 9 can be achieved. Specifically, by making the frame 92 cylindrical, the filter unit 9 can be easily molded.

While the embodiments, as shown, of the pressure control device of the disclosure are described above, the disclosure is not limited thereto. The respective parts forming the pressure control device can be replaced with any part of an arbitrary configuration having the same function. In addition, any arbitrary component may also be added. In addition, the filter member is not limited to being disposed along the direction of the central axis of the frame as in the above embodiment. For example, the filter member may also be disposed in an arched shape, and may also be bent in the shape of the letter “<”. Moreover, the plate-shaped filter member may also be disposed to be inclined with respect to the central axis of the frame. Furthermore, the plate-like member installed to the body is not limited to a plate (separate plate), but may also be other bodies in which a channel is formed.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A pressure control device, comprising:
a body having groove-like channel containing a groove part and a widened part which is connected with the groove part and of which a width is increased from the groove part;
a filter unit, which is a filter unit that captures a foreign matter mixed in a fluid passing through the groove-like channel and has a cylindrical frame formed of an elastic material and comprising a through hole part penetrating in a direction orthogonal to a central axis of the frame and a plate-shaped filter member disposed to cover the through hole part and supported on an inner side of the frame, wherein the filter unit is accommodated in the widened part with a direction of the central axis of the frame being arranged along a depth direction of the widened part; and
a plate-like member installed to the body to cover the groove-like channel in a state in which the filter unit is accommodated in the widened part,
wherein the frame has a length along the central axis greater than a depth of the widened part.

2. The pressure control device as claimed in claim 1, wherein the frame is provided, on an outer circumferential part of the frame, with a deformation absorbing part that absorbs deformation of the frame at a time when the filter unit is accommodated in the widened part and the plate-like member is installed to the body.

3. The pressure control device as claimed in claim 2, wherein the deformation absorbing part is configured to comprise a concave part in which the outer circumferential part of the frame is concave along the direction of the central axis and toward a side of the through hole part.

4. The pressure control device as claimed in claim 1, wherein the plate-like member is a plate installed to the body.

5. The pressure control device as claimed in claim 1, wherein two end surfaces in the direction of the central axis of the frame are flat surfaces.

6. The pressure control device as claimed in claim 1, wherein the filter unit is an insert molded product of the frame and the filter member.

7. The pressure control device as claimed in claim 1, wherein the filter unit has a regulating part regulating an arrangement direction with respect to the groove part.

8. The pressure control device as claimed in claim 7, wherein the regulating part has a protruding part protruding toward the groove part located on an upstream side or a downstream side of the widened part.

9. The pressure control device as claimed in claim 1, wherein the widened part is formed with a depth greater than a depth of the groove part and comprises a receiving part into which a portion of the filter unit is inserted.
